(19) United States
(12) Patent Application Publication
(10) Pub. No.: US 2019/0251430 A1
(43) Pub. Date: Aug. 15, 2019

(54) MIXED SIGNAL CMOS RPU WITH DIGITAL WEIGHT STORAGE

(71) Applicant: International Business Machines Corporation, Armonk, NY (US)

(72) Inventors: Tayfun Gokmen, Briarcliff Manor, NY (US); Seyoung Kim, Westchester, NY (US); Jinwook Oh, Yorktown Heights, NY (US)

(21) Appl. No.: 15/895,162

(22) Filed: Feb. 13, 2018

(51) Int. Cl. G06N 3/08; G06N 3/04

(52) U.S. Cl. CPC G06N 3/08; G06N 3/04

(57) ABSTRACT

A resistive processing unit (RPU) includes a coincidence detector to detect an overlapping signal between a row update line and a column update line, a counter receiving an output of the logic gate, storing a weight as a training methodology of the RPU, and changing the stored weight in response to an up/down signal applied to the counter, a digital to analog converter (DAC) receiving a digital value output from the counter and converting the digital value into an analog voltage, and a weight reading circuit for reading the weight using the analog voltage.

### BACKGROUND

### Technical Field

The methods and structures described herein relate in general to configurations of trainable resistive crosspoint devices, which are referred to herein as resistive processing units (RPUs). More particularly, the present description relates to artificial neural networks (ANNs) formed using complementary metal oxide semiconductor technology.

### Description of the Related Art

Resistive processing units (RPUs) indicate trainable resistive crosspoint circuit elements which can be used to build artificial neural networks (ANNs) and dramatically accelerate the ability of ANNs by providing local data storage and local data processing. Since a large network of RPUs are required to implement practical ANNs, finding a low-power and small-area RPU implementation can contribute to taking advantage of the RPU-based ANN implementation.

### SUMMARY

According to an exemplary embodiment of the invention, a resistive processing unit (RPU) is provided that includes a coincidence detector to detect an overlapping signal between a row update line and a column update line, a counter receiving an output of the coincidence detector, storing a weight as a training methodology of the RPU, and changing the stored weight in response to an up/down signal applied to the counter, a digital to analog converter (DAC) receiving a digital value output from the counter and converting the digital value into an analog voltage, and a weight reading circuit for reading the weight using the analog voltage.

According to an exemplary embodiment of the invention, a method of training a resistive processing unit (RPU) of an artificial neural network includes: applying, by a controller, a row update signal to a row line of the artificial neural network connect to a first input of a coincidence detector of the RPU; applying, by the controller, a column update signal to a column line of the artificial neural network connect to a second input of the coincidence detector; applying, by the controller, a control signal to increment or decrement a counter of the RPU; converting, by a digital to analog converter (DAC) of the RPU, a digital output of the counter to an analog voltage; and outputting the analog voltage to a weight reading circuit of the RPU as a weight of the RPU.

According to an exemplary embodiment of the invention, a method of implementing an artificial neural network (ANN) using a resistive processing unit (RPU) array includes: performing forward pass computations for the ANN via the RPU array by transmitting voltage pulses corresponding to input data of a layer of the ANN to read transistors of the RPU array, and storing values corresponding to currents output from the RPU array as output maps; performing backward pass computations for the ANN via the RPU array by transmitting voltage pulses corresponding to error of the output maps of the layer to the read transistors; and performing update pass computations for the ANN via the RPU array by transmitting voltage pulses corresponding to the input data of the layer and the error of the output maps to logic gates of the RPU array, where an output of each logic gate is connected to a corresponding counter of each RPU of the RPU array.

### BRIEF DESCRIPTION OF THE DRAWINGS

The following description will provide details for some embodiments of resistive processing units with reference to the following figures wherein:

FIG. 1 depicts a simplified diagram of input and output connections of a biological neuron.

FIG. 2 depicts a known simplified model of the biological neuron shown in FIG. 1.

FIG. 3 depicts a known simplified model of an ANN incorporating the biological neuron model shown in FIG. 2.

FIG. 4 depicts a simplified block diagram of a known weight update methodology.

FIG. 5 is a circuit diagram depicting an embodiment of a resistive processing unit (RPU) according to an exemplary embodiment of the invention.

FIG. 6 illustrates an example of a field effect transistor (FET), which can be used to implement transistor weight reading circuit of the resistive processing unit.

FIG. 7A is a circuit diagram depicting a forward and a backward pass operation that can be performed on the RPU of FIG. 5.

FIG. 7B is a circuit diagram depicting a weight updated operation that can be performed on the RPU of FIG. 5.

FIG. 8 illustrates a method updating and reading a weight of an RPU according to an exemplary embodiment of the invention.

FIG. 9 illustrates a method of training a neural network including the RPU according to an exemplary embodiment of the invention.

### DETAILED DESCRIPTION

Detailed embodiments of the claimed structures and methods are described herein; however, it is to be understood that the disclosed embodiments are merely illustrative of the claimed structures and methods that may be embodied in various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present description. For purposes of the description hereinafter, the terms “upper”, “lower”, “right”, “left”, “vertical”, “horizontal”, “top”, “bottom”, and derivatives thereof shall relate to the embodiments of the disclosure, as it is oriented in the drawing figures. The terms “positioned on” means that a first element, such as a first structure, is present on a second element, such as a second structure, wherein intervening elements, such as an interface structure, e.g. interface layer, can be present between the first element and the second element. The term “direct contact” means that a first element, such as a first structure, and a second element, such as a second structure, are connected without any intermediary conducting, insulating or semiconductor layers at the interface of the two elements.

“Machine learning” is used to broadly describe a primary function of electronic systems that learn from data. In machine learning and cognitive science, ANNs are a family of statistical learning models inspired by the biological neural networks of animals, and in particular the brain. ANNs can be used to estimate or approximate systems and functions that depend on a large number of inputs and are generally unknown.

It is understood in advance that although one or more embodiments are disclosed in the context of biological neural networks with a specific emphasis on modeling brain structures and functions, implementation of the teachings recited herein are not limited to modeling a particular environment. Rather, embodiments provided in the present description are capable of modeling any type of environment, including for example, weather patterns, arbitrary data collected from the internet, and the like, as long as the various inputs to the environment can be turned into a vector.

Although the methods and structures described herein are directed to an electronic system, for ease of reference and explanation various aspects of the disclosed electronic system are described using neurological terminology such as neurons, plasticity and synapses, for example. It will be understood that for any discussion or illustration herein of an electronic system, the use of neurological terminology or neurological shorthand notations are for ease of reference and are meant to cover the neuromorphic, ANN equivalent(s) of the described neurological function or neurological component.

ANNs, also known as neuromorphic or synaptronic systems, are computational systems that can estimate or approximate other functions or systems, including, for example, biological neural systems, the human brain and brain-like functionality such as image recognition, speech recognition and the like. ANNs incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

Instead of utilizing the traditional digital model of manipulating zeros and ones, ANNs create connections between processing elements that are substantially the functional equivalent of the core system functionality that is being estimated or approximated. For example, IBM's SyNapse computer chip is the central component of an electronic neuromorphic machine that attempts to provide similar form, function and architecture to the mammalian brain. Although the IBM SyNapse computer chip uses the same basic transistor components as conventional computer chips, its transistors are configured to mimic the behavior of neurons and their synapse connections. The IBM SyNapse computer chip processes information using a network of just over one million simulated “neurons,” which communicate with one another using electrical spikes similar to the synaptic communications between biological neurons. The IBM SyNapse architecture includes a configuration of processors (i.e., simulated “neurons”) that read a memory (i.e., a simulated “synapse”) and perform simple operations. The communications between these processors, which are typically located in different cores, are performed by on-chip network routers.

ANNs are often embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons which can be activated by the pixels of an input image. After being weighted and transformed by a function determined by the network's designer, the activations of these input neurons are then passed to other downstream neurons, which are often referred to as “hidden” neurons. This process is repeated until an output neuron is activated. The activated output neuron determines which character was read.

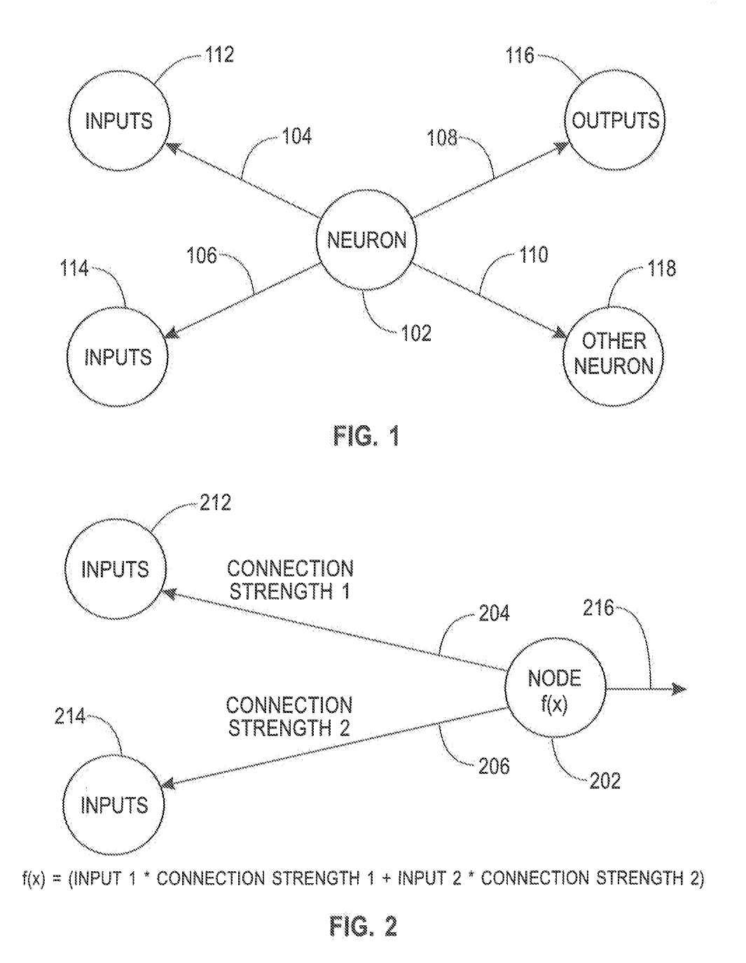

As background, a general description of how a typical ANN operates will now be provided with reference to FIGS. 1, 2 and 3. As previously noted herein, a typical ANN models the human brain, which includes about one hundred billion interconnected cells called neurons. FIG. 1 depicts a simplified diagram of a biological neuron 102 having pathways 104, 106, 108, 110 that connect it to upstream inputs 112, 114, downstream output s116 and downstream “other” neurons 118, configured and arranged as shown. Each biological neuron 102 sends and receives electrical impulses through pathways 104, 106, 108, 110. The nature of these electrical impulses and how they are processed in biological neuron 102 are primarily responsible for overall brain functionality. The pathway connections between biological neurons can be strong or weak. When a given neuron receives input impulses, the neuron processes the input according to the neuron's function and sends the result of the function to downstream outputs and/or downstream “other” neurons.

Biological neuron 102 is modeled in FIG. 2 as a node 202 having a mathematical function, f(x) depicted by the equation shown in FIG. 2. Node 202 takes electrical signals from inputs 212, 214, multiplies each input 212, 214 by the strength of its respective connection pathway 204, 206, takes a sum of the inputs, passes the sum through a function, f(x), and generates a result 216, which can be a final output or an input to another node, or both. In the present description, an asterisk (*) is used to represent a multiplication. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A typical design choice for f(x) is the hyperbolic tangent function, which takes the function of the previous sum and outputs a number between minus one and plus one.

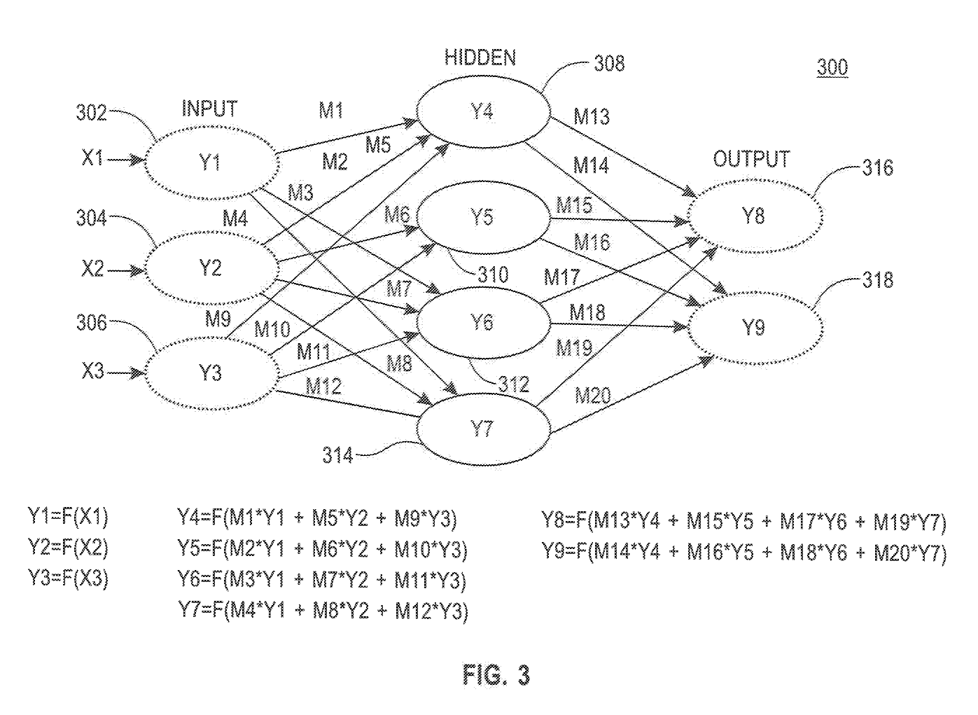

FIG. 3 depicts a simplified ANN model 300 organized as a weighted directional graph, wherein the artificial neurons are nodes (e.g., 302, 308, 316), and wherein weighted directed edges (e.g., m1 to m20) connect the nodes. ANN model 300 is organized such that nodes 302, 304, 306 are input layer nodes, nodes 308, 310, 312, 314 are hidden layer nodes and nodes 316, 318 are output layer nodes. Each node is connected to every node in the adjacent layer by connection pathways, which are depicted in FIG. 3 as directional arrows having connection strengths m1 to m20. Although only one input layer, one hidden layer and one output layer are shown, in practice, multiple input layers, hidden layers and output layers can be provided.

Similar to the functionality of a human brain, each input layer node 302, 304, 306 of ANN 300 receives inputs x1, x2, x3 directly from a source (not shown) with no connection strength adjustments and no node summations. Accordingly, y1=f(x1), y2=f(x2) and y3=f(x3), as shown by the equations listed at the bottom of FIG. 3. Each hidden layer node 308, 310, 312, 314 receives its inputs from all input layer nodes 302, 304, 306 according to the connection strengths associated with the relevant connection pathways. Thus, in hidden layer node 308, y4=f(m1*y1+m5*y2+m9*y3), wherein * represents a multiplication. A similar connection strength multiplication and node summation is performed for hidden layer nodes 310, 312, 314 and output layer nodes 316, 318, as shown by the equations defining functions y5 to y9 depicted at the bottom of FIG. 3.

ANN model 300 processes data records one at a time, and it “learns” by comparing an initially arbitrary classification of the record with the known actual classification of the record. Using a training methodology knows as “backpropagation” (i.e., “backward propagation of errors”), the errors from the initial classification of the first record are fed back into the network and used to modify the network's weighted connections the second time around, and this feedback process continues for many iterations. In the training phase of an ANN, the correct classification for each record is known, and the output nodes can therefore be assigned “correct” values. For example, a node can be assigned a node value of “1” (or 0.9) for the node corresponding to the correct class, and a node value of “0” (or 0.1) for the others. It is thus possible to compare the network's calculated values for the output nodes to these “correct” values, and to calculate an error term for each node (i.e., the “delta” rule). These error terms are then used to adjust the weights in the hidden layers so that in the next iteration the output values will be closer to the “correct” values.

There are many types of neural networks, but the two broadest categories are feed-forward and feedback/recurrent networks. ANN model 300 is a non-recurrent feed-forward network having inputs, outputs and hidden layers. The signals can only travel in one direction. Input data is passed onto a layer of processing elements that perform calculations. Each processing element makes its computation based upon a weighted sum of its inputs. The new calculated values then become the new input values that feed the next layer. This process continues until it has gone through all the layers and determined the output. A threshold transfer function is sometimes used to quantify the output of a neuron in the output layer.

A feedback/recurrent network includes feedback paths, which mean that the signals can travel in both directions using loops. All possible connections between nodes are allowed. Because loops are present in this type of network, under certain operations, it may become a non-linear dynamical system that changes continuously until it reaches a state of equilibrium. Feedback networks are often used in associative memories and optimization problems, wherein the network looks for the best arrangement of interconnected factors.

The speed and efficiency of machine learning in feed-forward and recurrent ANN architectures depend on how effectively the crosspoint devices of the ANN crossbar array perform the core operations of typical machine learning algorithms. Although a precise definition of machine learning is difficult to formulate, a learning process in the ANN context can be viewed as the problem of updating the crosspoint device connection weights so that a network can efficiently perform a specific task. The crosspoint devices typically learn the necessary connection weights from available training patterns. Performance is improved over time by iteratively updating the weights in the network. Instead of following a set of rules specified by human experts, ANNs “learn” underlying rules (like input-output relationships) from the given collection of representative examples. Accordingly, a learning algorithm may be generally defined as the procedure by which learning rules are used to update and/or adjust the relevant weights.

The three main learning algorithm paradigms are supervised, unsupervised and hybrid. In supervised learning, or learning with a “teacher,” the network is provided with a correct answer (output) for every input pattern. Weights are determined to allow the network to produce answers as close as possible to the known correct answers. Reinforcement learning is a variant of supervised learning in which the network is provided with only a critique on the correctness of network outputs, not the correct answers themselves. In contrast, unsupervised learning, or learning without a teacher, does not require a correct answer associated with each input pattern in the training data set. It explores the underlying structure in the data, or correlations between patterns in the data, and organizes patterns into categories from these correlations. Hybrid learning combines supervised and unsupervised learning. Parts of the weights are usually determined through supervised learning, while the others are obtained through unsupervised learning. Additional details of ANNs and learning rules are described in Artificial Neural Networks: A Tutorial, by Anil K. Jain, Jianchang Mao and K. M. Mohiuddin, IEEE, March 1996, the entirety of which is incorporated by reference herein.

As previously noted herein, in order to limit power consumption, the crosspoint devices of ANN chip architectures are often designed to utilize offline learning techniques, wherein the approximation of the target function does not change once the initial training phase has been resolved. Offline learning allows the crosspoint devices of crossbar-type ANN architectures to be simplified such that they draw very little power.

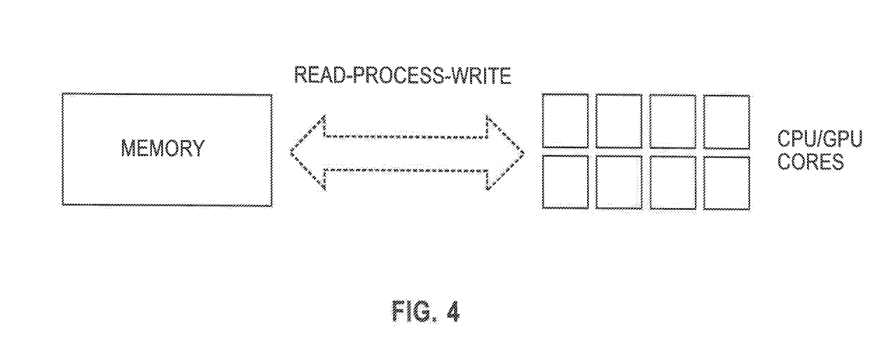

Notwithstanding the potential for lower power consumption, executing offline training can be difficult and resource intensive because it is typically necessary during training to modify a significant number of adjustable parameters (e.g., weights) in the ANN model to match the input-output pairs for the training data. FIG. 4 depicts a simplified illustration of a typical read-process-write weight update operation, wherein CPU/GPU cores (i.e., simulated “neurons”) read a memory (i.e., a simulated “synapse”) and perform weight update processing operations, then write the updated weights back to memory.

In some embodiments, the methods, structures and systems disclosed herein provide a circuit including a logic circuit (e.g., an AND gate), a counter, a digital to analog converter (DAC), and a transistor (e.g., a metal oxide semiconductor field effect transistors (MOSFETs)), which can function as a resistive processing unit (RPU) used to indicate trainable resistive crosspoint circuit elements. As used herein a “field effect transistor” is a transistor in which output current, i.e., source-drain current, is controlled by the voltage applied to the gate. A field effect transistor has three terminals, i.e., a gate structure, a source region and a drain region. A “gate structure” means a structure used to control output current (i.e., flow of carriers in the channel) of a semiconducting device through electrical or magnetic fields. As used herein, the term “drain” means a doped region in semiconductor device located at the end of the channel, in which carriers are flowing out of the transistor through the drain. As used herein, the term “source” is a doped region in the semiconductor device, in which majority carriers are flowing into the channel.

In some embodiments, the circuit disclosed herein has the ability to switch its resistance with 1000 or more resistance states in an incremental and symmetric manner and also with very low power at high speed. The state variable of an RPU is stored in a counter in the form of multi-bit value output to a DAC.

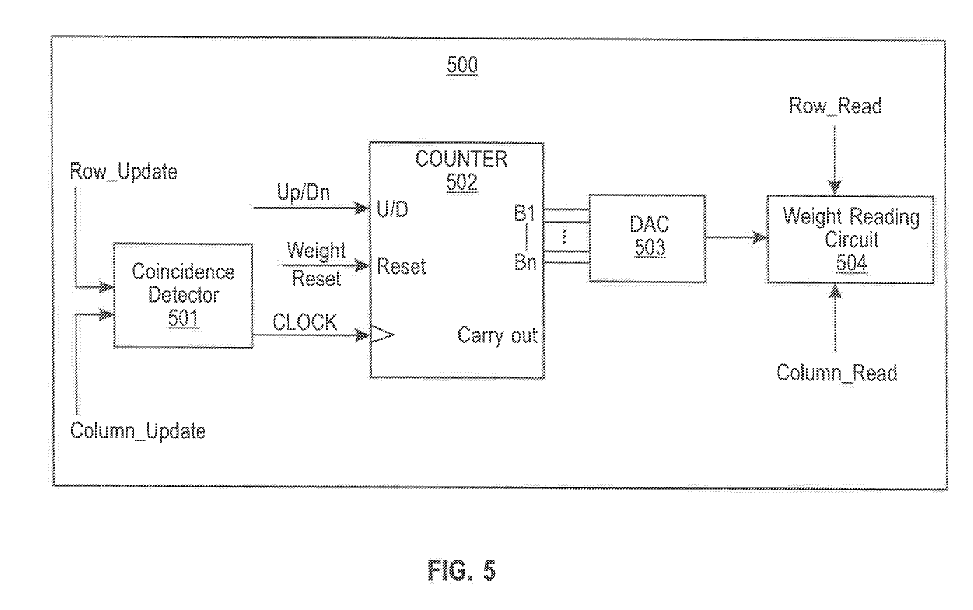

FIG. 5 depicts one embodiment of a circuit diagram of an RPU cell 500 including a coincidence detector 501, a counter 502, a DAC 503, and a weight reading circuit 504 (e.g., a read transistor such as a MOSFET). In an exemplary embodiment, the coincidence detector 501 is implemented by an AND gate. In an exemplary embodiment, the counter 502 is implemented by a multi-bit digital counter. When the weight reading circuit 504 is implemented by a read transistor, a gate terminal of the read transistor is connected to an output of the DAC 503 and the resistance of the read transistor is tuned as a function of the voltage output by the DAC 503. For example, the read transistor can be provided by an n-type MOSFET. Although, the read transistor is described as a MOSFET, it is noted that any field effect transistor (FET) or switching semiconductor device may be used to implement the read transistor of the RPU cell 500, such as a Fin-type field effect transistor (FinFET), a vertical fin type field effect transistor (v-FinFET), a bipolar junction transistor, a junction transistor and combinations thereof.

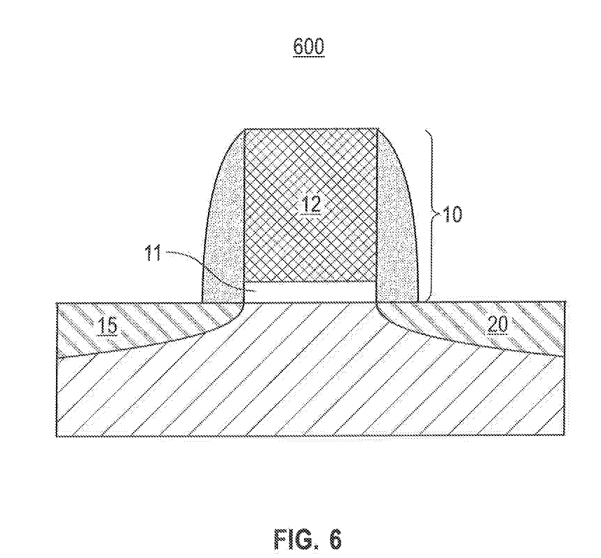

One example of a field effect transistor (FET) 600 which can be used to implement the read transistor and that is formed using CMOS semiconductor device technology is depicted in FIG. 6. Referring to FIG. 6, in one example, the field effect transistor (FET) 600 that is used in the RPU units described herein can include a gate structure 10, source region 15 and drain region 20. The gate structure 10 is present on the channel region of the device separating the source region 15 from the drain region 20, in which applying electrical current to the gate structure 10 switches the device from an on current state to an off current state. The gate structure 10 typically includes a gate dielectric 11 that is present on the channel region portion of the substrate of the device, and a gate electrode 12 that is present on the gate dielectric 11.

The gate dielectric 11 can be composed of an oxide, nitride or oxynitride. For example, the gate dielectric 11 can be composed of silicon oxide (SiO₂). In other examples, the gate dielectric 11 is composed of a high-k dielectric material, e.g., a dielectric material having a dielectric constant greater than silicon oxide, e.g., hafnium oxide (HfO₂). Following deposition of the material layer for the gate dielectric 11, a material layer for the gate conductor 12 may be deposited to form the material stack for the gate structure 10. The gate conductor 12 may be composed of an electrically conductive material, such as a metal, e.g., tungsten (W); a metal nitride, e.g., tungsten nitride (WN); and/or a doped semiconductor, such as n-type doped polysilicon. In a following process step, an etch mask is formed atop the portion of the material stack for forming the gate structure 10 using photolithography. In some embodiments, the etch mask is composed of a photoresist. In other embodiments, the etch mask includes a hard mask dielectric. In some embodiments, following formation of the etch mask, the material stack is etched, e.g., etched with an anisotropic etch process, such as reactive ion etch (RIE), to form the gate structure 10. A gate sidewall spacer can be formed on the sidewalls of the gate structure 10. The gate sidewall spacer may be composed of a dielectric, such as silicon nitride. The gate sidewall spacer can be formed using a deposition process, such as chemical vapor deposition (CVD), followed by an etch back process. In a following process step, the source and drain regions 15, 20 are ion implanted into the semiconductor substrate, as shown in FIG. 6, using ion implantation and an n-type or p-type dopant. The selection of an n-type or p-type dopant for the source and drain regions 10, 15 typically dictates the conductivity type of the semiconductor device, i.e., whether the device has an n-type or p-type conductivity. N-type dopants produce an excess of electrons so that charge carriers are provided by electrons. P-type dopants provide a deficiency of electrons, i.e., holes. The charge carriers in p-type conductivity devices are holes. In some embodiments, the source and drain regions are formed atop the substrate on portions of the substrate that are adjacent to the channel region portions using epitaxial growth processes.

The aforementioned process sequence is referred to as a gate first process sequence, in which the gate structures are before the source and drain regions. The FETs used with the RPU units described herein can also be formed using a gate last process. In a gate last process, a sacrificial gate structure is first formed on the channel region of the device; source and drain regions are formed while the sacrificial gate structure is present; and following forming the source and drain regions the sacrificial gate structure is replaced with a functional gate structure. In a gate last process, the gate functional gate structure may not be subjected to the activation anneal applied to the source and drain regions.

Referring back to FIG. 5, the DAC 503 is able to convert one or more output bits of the multi-bit counter 502 into a voltage for output to the weight reading circuit 504. When the weight reading circuit 504 is implemented by a read transistor, the voltage is output from the DAC 503 to a gate terminal of the read transistor. In an embodiment, the DAC 503 is able to convert a number of most significant bits output by the multi-bit counter 502. For example, the DAC 503 need not be configured to convert the least significant bits output by the multi-bit counter 502. For example, while FIG. 5 depicts an n-bit counter 502 outputting all n bits to the DAC 503, in an alternate embodiment, the counter 502 outputs less than these n bits to the DAC (e.g., only the most significant 3 bits, 5 bits, 7 bits, etc.). However, the invention is not limited to use of a n-bit counter and an n-bit DAC, as these numbers can be changed, so long as the number of bits the DAC 503 is capable of converting is less than or equal to the number of bits stored and output by the multi-bit counter 502. In one embodiment, the counter 502 is an n-bit counter and the DAC 503 is an m-bit DAC, where m is less than N. For example, in one embodiment, n is 10 and m is 4 so that a 10-bit counter 502 and a 4-bit DAC 503 are present. In this embodiment, one only probes the most significant 4 bits output from the counter 502, and the impact on the neural network training results may be minimal. An embodiment that uses an n-bit counter 502 and an m-bit DAC 503 may use less area than an embodiment that uses an n-bit counter 502 and an n-bit DAC 503.

The coincidence detector 501 provides an update function for a weight of a training methodology to the RPU 500. The weight reading circuit 504 is provided for reading the weight of the training methodology for the RPU 500. The multi-bit counter 502 stores the weight of training methodology for the RPU 500.

When a current is applied to the first and second update lines Row_Update, Column_Update connected as inputs to the coincidence detector 501, the output of the coincidence detector 501 is applied to a clock terminal of the multi-bit counter 502, and the value of the multi-bit counter 502 is incremented or decremented based on a state of an up/down weight signal UP/DN applied to the multi-bit counter 502. The up/down signal UP/DN indicates whether the counter 502 is to be incremented or decremented. For example, the up/down signal UP/DN may have a first logic level (e.g., logic high) to indicate the counter 502 is to be incremented and a second logic level (e.g., a logic low) to indicate the counter 502 is to be decremented. The counter 502 may additionally include a reset terminal to which a weight reset signal is applied initially or when the neural network is to be retrained for a new problem. For example, the weight reset signal may be used to reset the counter 502 at the beginning of the training or anytime the weight needs to be initialized. The counter 502 is not automatically reset when it reaches its maximum supported value, so that it won't lose the weight when it reaches this maximum. The up/down and/or weight reset signal may be provided by a control circuit, a microprocessor, or a computer as an example. For example, the computer may store a program that is configured to train the neural network that initially applies the reset signal and thereafter trains the RPUs of the neural network by updating the RPUs.

In an embodiment where the coincidence detector 501 is implemented by an AND gate 501, signals applied to the Row_Update and Column Update lines are applied to inputs of the AND gate, and the output of the AND gate conducts current when only both the signals applied to the Row_Update and Column_Update lines are coincided to be ON.

In an embodiment, the multi-bit counter 502 stores a weight of training for resistive crosspoint circuit elements of an artificial neural network.

In an embodiment, when the weight reading circuit 504 is implemented by a read transistor, the read transistor can be a field effect transistor. The gate of the read transistor is connected to the output of the DAC 503. One of the source and drain regions (e.g., the source region) of the read transistor is connected to a Row_Read line and the other of the source and drain regions (e.g., the drain region) of the read transistor is connected to the Column_Read line. The read transistor can be a variable resistor (e.g., a potentiometer) for reading the weight stored within the multi-bit counter 502. More specifically, in some embodiments, the read transistor reads a weight of training through its channel resistance. In some embodiments, the channel resistance is modulated by the voltage output by the DAC 503 consistent with the weight of training stored within the multi-bit counter 502.

Referring to FIG. 5, in one embodiment, the multi-bit counter 502 stores a multi-bit pattern which represents the weight value stored in the RPU unit 500, and the coincidence detector 501 serves as an update device to increment/decrement the multi-bit counter 502 and change the stored weight value. When the weight reading circuit 504 is implemented by a read transistor, it is a transistor whose channel resistance is modulated by the voltage output by the DAC 503. One can read out the stored weight by measuring the channel resistance of the read transistor.

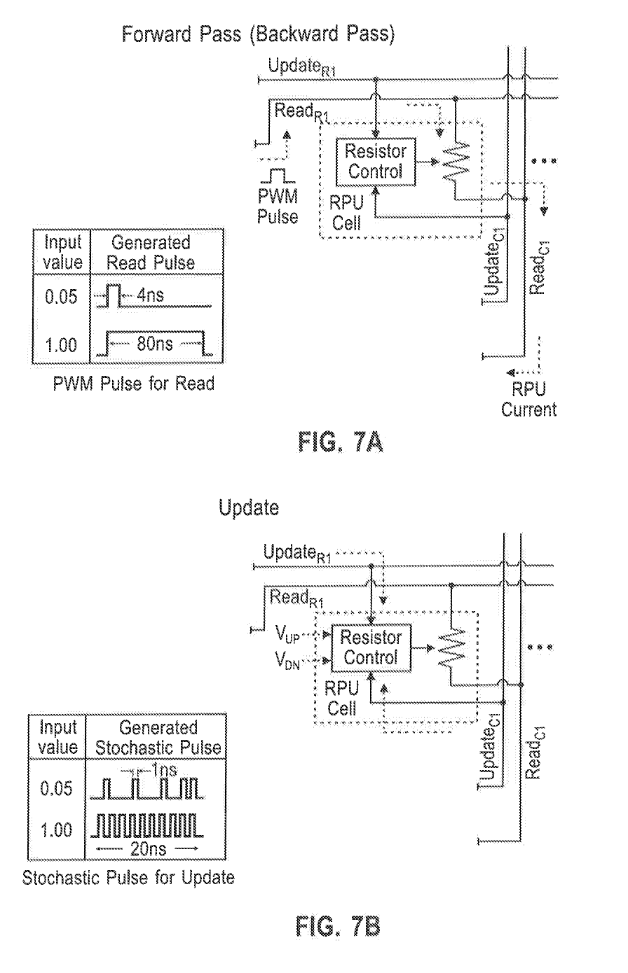

FIG. 7A is a circuit diagram including an RPU cell that can be implemented by the RPU 500 of FIG. 5 operating in a forward or backward pass operation. During the forward pass, input data is applied in the form of voltage amplitudes, pulse width or stochastic bitstreams and are multiplied by the internal weights stored in the RPU. During the backward pass, calculated delta value data is applied in the form of voltage amplitudes, pulse width or stochastic bitstreams and are multiplied by ₜhe internal weights stored in the RPU.

FIG. 7B is a circuit diagram including an RPU cell that can be implemented by the RPU 500 of FIG. 5 operating in a weight update mode. During the weight update operation, the input data and delta value data previously calculated in the forward and backward operations are provided to the RPU cell, and the weight stored in the RPU cell is updated by the amount corresponding to the multiplication of input data and the delta value data.

In another aspect, a method for storing weight of training in a resistive processing unit (RPU) of an artificial neural network (ANN) is provided that includes providing a multi-bit counter 503 for storing a weight of training for resistive crosspoint circuit elements for an artificial neural network (ANN).

In some embodiments, updating the weight of training stored in the multi-bit counter 502 includes incrementing or decrementing the multi-bit counter 502 by using the coincidence detector 501 and applying the UP/DN signal. In some embodiments, the read transistor reads a weight of training stored in the multi-bit counter 502 through a channel resistance of the read transistor. The channel resistance of the read transistor is modulated by the voltage output by the DAC 503 consistent with the weight of training stored in the multi-bit counter 502.

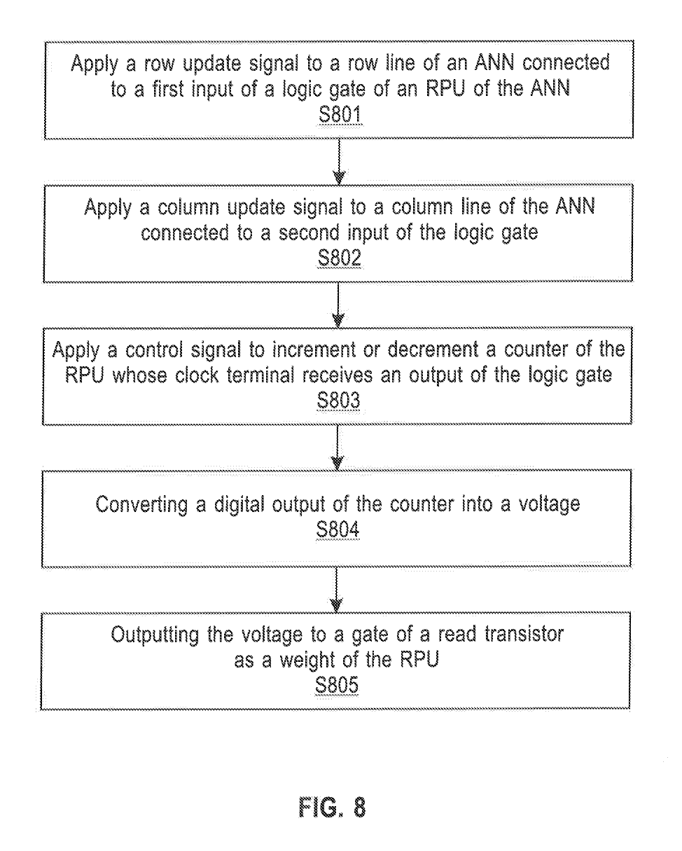

FIG. 8 illustrates a method of training an RPU of an artificial neural network (ANN) according to an exemplary embodiment of the invention. Referring to FIG. 8, the method includes applying a row update signal to a row line of the ANN connected to a first input of a logic gate of an RPU of the ANN (S801), applying a column update signal to a column line of the ANN connected to a second input of the logic gate (S802), applying a control signal to increment or decrement a count of the RPU whose clock terminal receives an output of the logic gate (S803), converting a digital output of the counter into a voltage (S804), and applying the voltage to a gate of the read transistor as weight of the RPU (S805).

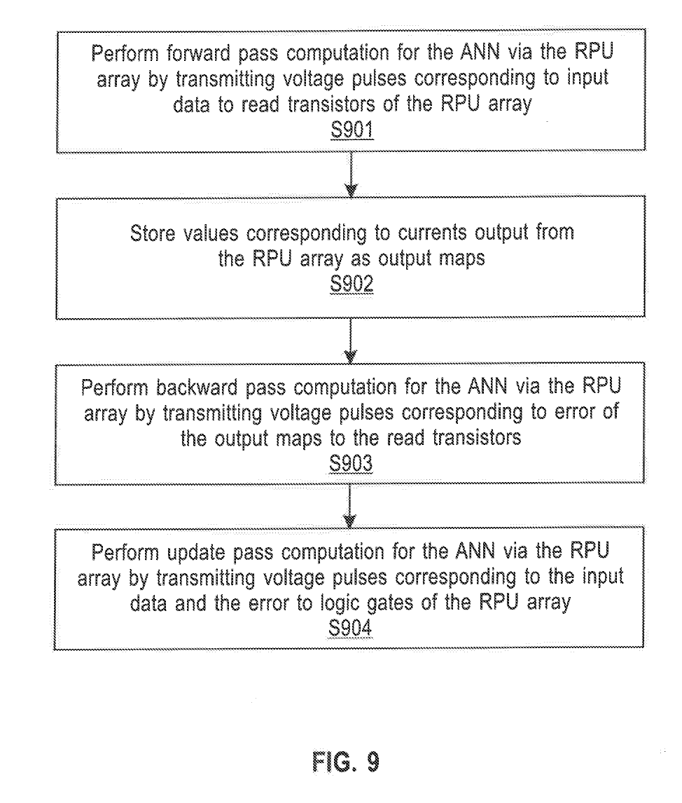

FIG. 9 illustrates a method of training an ANN according to an exemplary embodiment of the invention. Referring to FIG. 9, the method includes performing forward pass computations for the ANN via the RPU array by transmitting voltage pulses corresponding to input data to read transistors of the RPU array (S901) and storing values corresponding to currents output from RPU array as output maps (S902). For example, the voltage pulses may be applied to source terminals of the read transistors. The method further includes performing backward pass computations for the ANN via the RPU array by transmitting voltage pulses corresponding to error of the output maps to the read transistors (S903). The method further includes performing update pass computations for the ANN via the RPU array by transmitting voltage pulses corresponding to the input data and the error to logic gates of the RPU array (S904).

Having described preferred embodiments of the resistive processing unit (RPU) disclosed herein (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims.

What is claimed is:

1. A resistive processing unit (RPU) comprising:
a coincidence detector to detect an overlapping signal between a row update line and a column update line;
a counter receiving an output of the coincidence detector, storing a weight as a training methodology of the RPU, and changing the stored weight in response to an up/down signal applied to the counter;
a digital to analog converter (DAC) receiving a digital value output from the counter and converting the digital value into an analog voltage; and
a weight reading circuit for reading the weight using the analog voltage.

2. The RPU of claim 1, wherein the coincidence detector is an AND gate and the weight reading circuit is a read transistor.

3. The RPU of claim 2, wherein a gate terminal of the read transistor receives the analog voltage.

4. The RPU of claim 2, wherein the read transistor is a metal oxide semiconductor field effect transistor.

5. The RPU of claim 2, wherein an output of the AND gate is provided to a clock terminal of the counter.

6. The RPU of claim 5, wherein a first input to the AND gate is connected to the row update line and a second input to the AND gate is connected to the column update line.

7. The RPU of claim 1, wherein the counter is an N bit counter, the DAC is an M bit DAC, wherein N and M are natural numbers and M is less than or equal to N.

8. The RPU of claim 1, wherein the up/down signal is applied to a terminal of the counter used for incrementing or decrementing the counter.

9. The RPU of claim 2, wherein the read transistor reads the weight through a channel resistance of the read transistor.

10. The RPU of claim 2, wherein one of a source and a drain of the read transistor is connected to a row read line and the other of the source and the drain is connected to a column read line.

11. A method of training a resistive processing unit (RPU) of an artificial neural network (ANN) comprising:
applying, by a controller, a row update signal to a row line of the ANN connected to a first input of a coincidence detector of an RPU of the ANN;
applying, by the controller, a column update signal to a column line of the ANN connected to a second input of the coincidence detector;
applying, by the controller, a control signal to increment or decrement a counter of the RPU;
converting, by a digital to analog converter (DAC) of the RPU, a digital output of the counter to an analog voltage; and
outputting the analog voltage to a weight reading circuit of the RPU as a weight of the RPU.

12. The method of claim 11, wherein the coincidence detector is an AND gate and the weight reading circuit is a read transistor, where a gate terminal of the read transistor receives the analog voltage.

13. The method of claim 12, wherein an output of the AND gate is provided to a clock terminal of the counter.

14. The method of claim 11, wherein the counter is an N bit counter, the DAC is an M bit DAC, wherein N and M are natural numbers and M is less than or equal to N.

15. The method of claim 12, wherein the read transistor is a metal oxide semiconductor field effect transistor.

16. The method of claim 12, wherein the read transistor reads the weight of training through a channel resistance of the read transistor.

17. A method of implementing an artificial neural network (ANN) using a resistive processing unit (RPU) array, the method comprising:
performing forward pass computations for the ANN via the RPU array by transmitting voltage pulses corresponding to input data of a layer of the ANN to read transistors of the RPU array, and storing values corresponding to currents output from the RPU array as output maps;
performing backward pass computations for the ANN via the RPU array by transmitting voltage pulses corresponding to error of the output maps of the layer to the read transistors; and
performing update pass computations for the ANN via the RPU array by transmitting voltage pulses corresponding to the input data of the layer and the error of the output maps to logic gates of the RPU array,
where an output of each logic gate is connected to a corresponding counter of each RPU of the RPU array.

18. The method of claim 17, wherein each RPU comprises a digital to analog converter (DAC) configured to convert an output of the counter into a voltage for output to a gate of a corresponding one of the read transistors.

19. The method of claim 18, wherein each logic gate is an AND gate and the output of the AND gate is connected to a clock terminal of the counter.

20. The method of claim 17, wherein the counter is an N bit counter, the DAC is an M bit DAC, wherein N and M are natural numbers and M is less than or equal to N.
